(19) United States
(12) Patent Application Publication
(10) Pub. No.: US 2011/0227738 A1
(43) Pub. Date: Sep. 22, 2011

(54) WEARABLE ELECTRONIC GROUND INTEGRITY MONITOR

(76) Inventors: Guy T. McIlroy, Los Gatos, CA (US); Bruce C. Lundeen, Fremont, CA (US); Ching Chieh Allen Wu, San Jose, CA (US); Cuong Tran, Fremont, CA (US); Robin Chung, Milpitas, CA (US)

(21) Appl. No.: 13/048,354

(22) Filed: Mar. 15, 2011

Related U.S. Application Data
(63) Continuation-in-part of application No. 61/315,306, filed on Mar. 18, 2010.

(51) Int. Cl. G08B 23/00

(52) U.S. Cl. 340/573.1

(57) ABSTRACT

A device that can electronically track operator ground connectivity to; a) provide continuous visual and/or auditory indication of connection state, b) optionally provide that the ground connectivity state may be monitored and displayed remotely using RF communications, and c) optionally provide that the operators device can track RFID ‘follower’ tags specifically placed to facilitate work-flow data recording and the correlation of the operators activities with specific work-flow process.

### RELATED APPLICATIONS

The present application is a continuation-in-part application of U.S. provisional patent application, Ser. No. 61/315,306, filed Mar. 18, 2010, for SINGLE WIRE, WEARABLE, ELECTRONIC GROUND RESISTANCE DETECTOR FOR ESD WORKPLACE PROTECTION, by Guy T R Mcllroy, included by reference herein and for which benefit of the priority date is hereby claimed.

### FIELD OF THE INVENTION

The present invention relates to industrial and other operations that are sensitive to the build-up and discharge of electro-static energy, and, more particularly, to electronic industries, paint shops and grain silos where electrostatic discharge may cause component damage, equipment damage, injury or death.

### BACKGROUND OF THE INVENTION

Electrostatic energy build-up and discharge is a relatively well-understood operational problem. Under specific circumstances, materials and/or the operator and/or their clothing can become charged with significant electrostatic potential.

The uncontrolled discharge of this potential can destroy electronic components and can cause dangerous dust or particle explosions. The prevention of static build-up on operators in certain industries has significant economic and safety implications.

In electronic process and manufacturing industries, electrostatic discharge (ESD) is a serious issue for solid-state electronics, such as integrated circuits. Integrated circuits are made from semiconductor materials such as silicon and insulating materials such as silicon dioxide. Either of these materials can suffer permanent damage when subjected to high voltages as a result of ESD through the device.

For these industries, there are two main methods of protection. Firstly, the device under construction may be designed in ways that mitigate the effect of an ESD event by routing the energy away from sensitive areas. Many IC and board designs use this approach. Secondly, standard manufacturing procedures require that all assembly personnel and equipment be adequately grounded. Adequate grounding of the operator and equipment prevents harmful voltages from accumulating and the handling of components and devices is protected from ESD events.

In recent years, there have been significant advances in the use of local and personal area networks and in the use of RF identification tags (RFID). These technologies have, so far, not been applied effectively to the ESD industry. Whereas there are wireless solutions in the market place, they are power hungry requiring sizeable batteries to make them work and are thus not wrist strap implementations.

For a static wrist/heel strap, the integrity of the ground connection is tested once per day at a test stand or each time the technician returns to the manufacturing area. This test is from the ground through the body through the wrist/heel strap and back to the ground.

There are existing solutions that provide ground protection and monitoring. Existing solutions may be loosly divided into passive and active categories. Passive—without continuous monitoring, active—with continuous monitoring.

Existing passive solutions, whilst low cost, have the significant and very specific limitation of only assuring adequate grounding at the time of the test. They are not able to positively assure grounding at the specific time of contact with the work. Manufacturers are unable to ensure ESD protection during manufacture of a clients product and rely on safe working practices to assure that the process was likely to be protected.

Existing active solutions involve the use of complex wiring infrastructure to both ground the user and measure the ground potential separately. In particular, these devices are typically exclusively located on each bench that the operator may use. They involve the maintenance of an expensive grounded work-station that is difficult to move and difficult to monitor remotely.

Further, for both types of system, it is often difficult if not impossible for a customer to resolve a damaged board to a possible ESD event after the fact. With no record of any ground faults and no record of specifically when a board was worked on or by whom, the customer relies heavily on the adequate maintenance of operational standard practices with little to no visibility of the process.

It is therefore an object of the invention to provide a means of electronic monitoring an operators ground connection and provide continuous visual and/or auditory feedback to the operator of the ground connection state.

It is another object of the invention to provide the means by which the operator and ground connection state can be correlated against process parameters including but not limited to work-flow, components, followers and work place location using RFID and other pertinent technology.

It is another object of the invention to provide the means by which the various related operational parameters described above may be communicated wirelessly to a remote data logging and presentation device.

### SUMMARY OF THE INVENTION

In accordance with the present invention, there is provided a device that can electronically track operator ground connectivity to; a) provide continuous visual and/or auditory indication of connection state, b) optionally provide that the ground connectivity state may be monitored and displayed remotely using RF communications, and c) optionally provide that the operators device can track RFID ‘follower’ tags specifically placed to facilitate work-flow data ecording and the correlation of the operators activities with specific work-flow process.

### BRIEF DESCRIPTION OF THE DRAWINGS

A complete understanding of the present invention may be obtained by reference to the accompanying drawings, when considered in conjunction with the subsequent, detailed description, in which:

FIG. 1 is a typical current solution (1) view of an existing solution to passively tie the operator and the work-station to ground—grounding acuity depends on periodic testing with no real-time assurance;

FIG. 2 is a typical current solution (2) view of an active solution to monitor the work area and the operator-disadvantages are more expense and the limitations of working only in specifically designed work areas;

FIG. 3 is a typical current solution (3) view of a set of bench monitoring stations that may be linked together using wired networking for central monitoring;

FIG. 4 is a wristband view of an implementation designed to be worn on the wrist of the operator;

FIG. 5 is a described solution (1) view of a typical scenario—by using an active device, simple work-stations and even arbitrary work locations (in a server farm, paint-shop or grain silo) can be used effectively using a single ground connection (wrist or heel) without the need for complex wiring or testing;

FIG. 6 is a wrist/heel strap w. rf & rfid view of a deployment rendering the invention in different forms—many ground connectivity solutions may be provided and the addition of rf communications and rfid significantly increases the utility of the invention;

FIG. 7 is a principles of operation view of a ground monitoring sensor; and

FIG. 8 is a perspective and sectional views view of a wristband implementation.

For purposes of clarity and brevity, like elements and components will bear the same designations and numbering throughout the Figures.

### DESCRIPTION OF THE PREFERRED EMBODIMENT

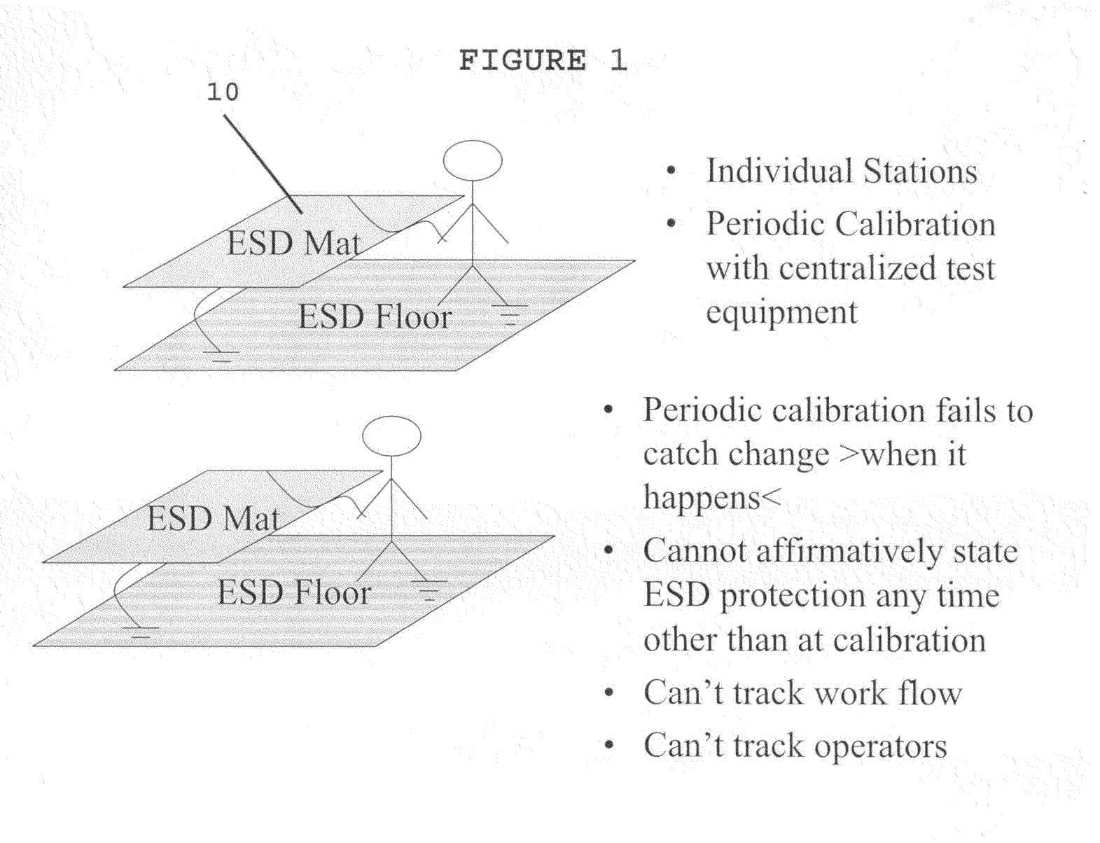

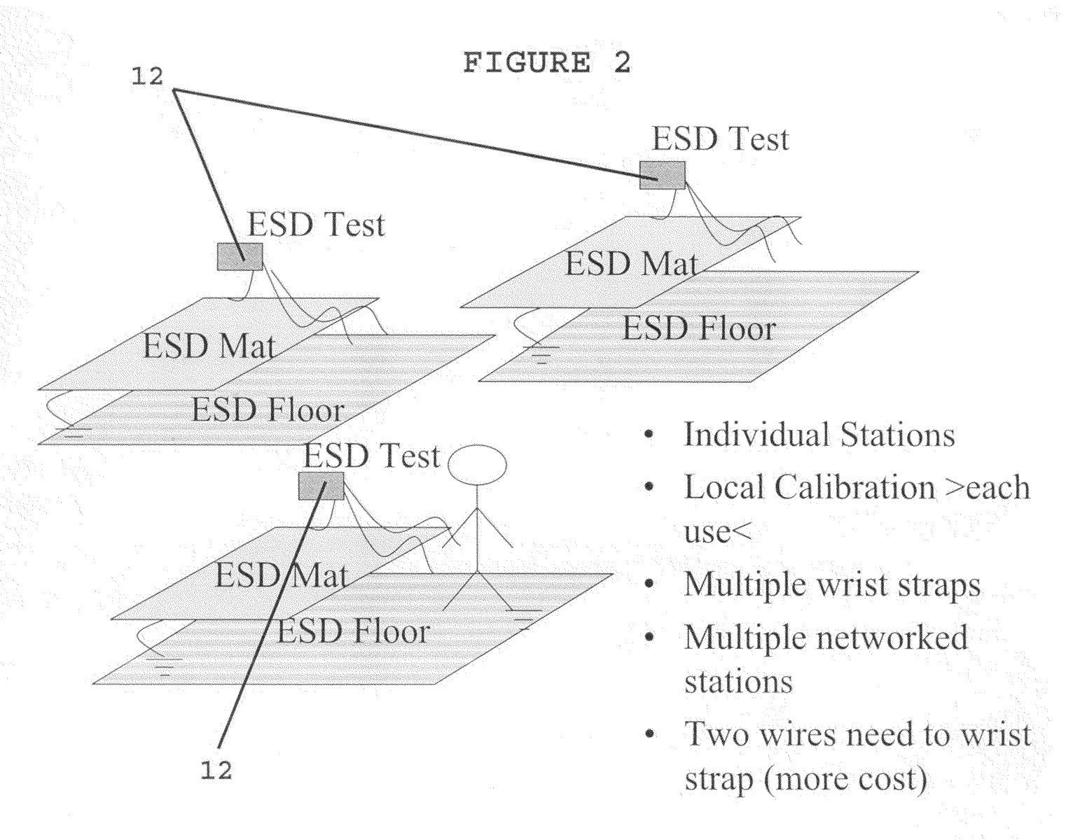

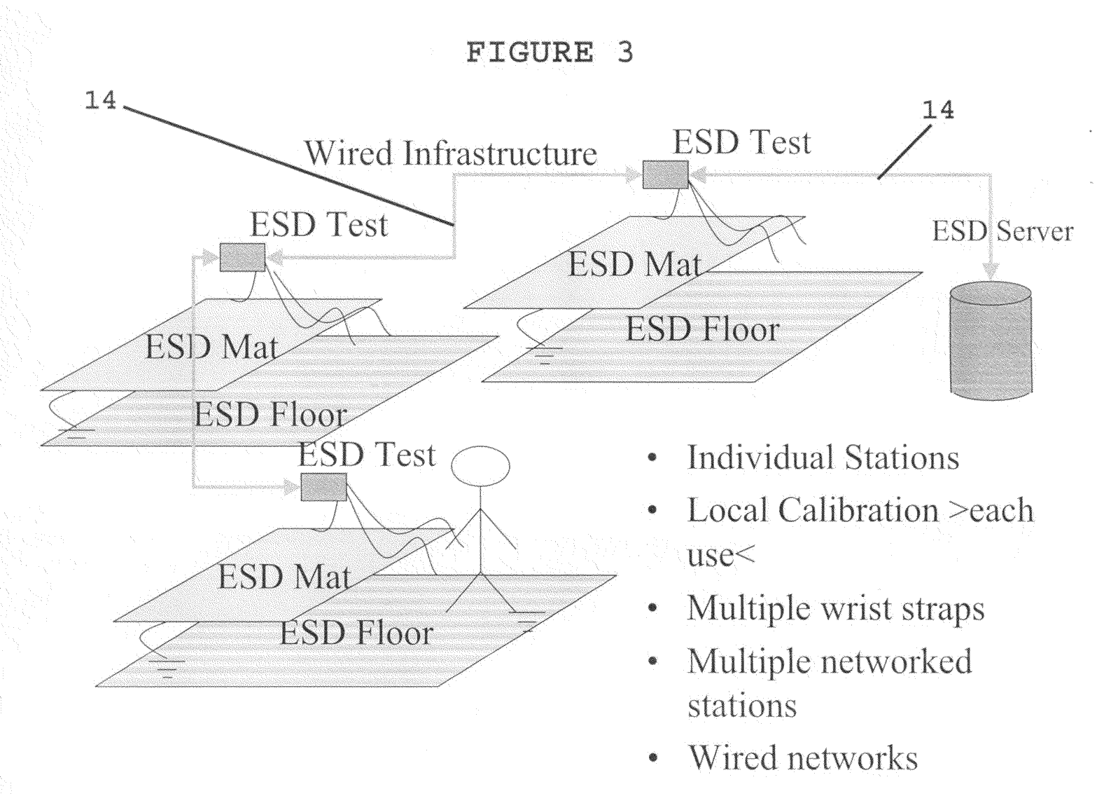

FIG. 1 shows a typical existing passive current solution. The operator is tied to a grounded assembly/test Workstation 10 using a passive grounding device that is tested daily. Workstations are typically tested for ground continuity quarterly. Grounding acuity depends on periodic testing with no real-time ground continuity assurance during time of actual assembly. FIG. 2 is a typical existing active solution where devices are installed at the Workstation 10 to monitor the work area and the operator (Installed active ground Monitor 12). Disadvantages are more expense if infrastructure installation and maintenance along with limitations of working only in specifically designed work areas. Active solutions may be linked together using Wired Infrastructure 14 for central monitoring as shown in FIG. 3.

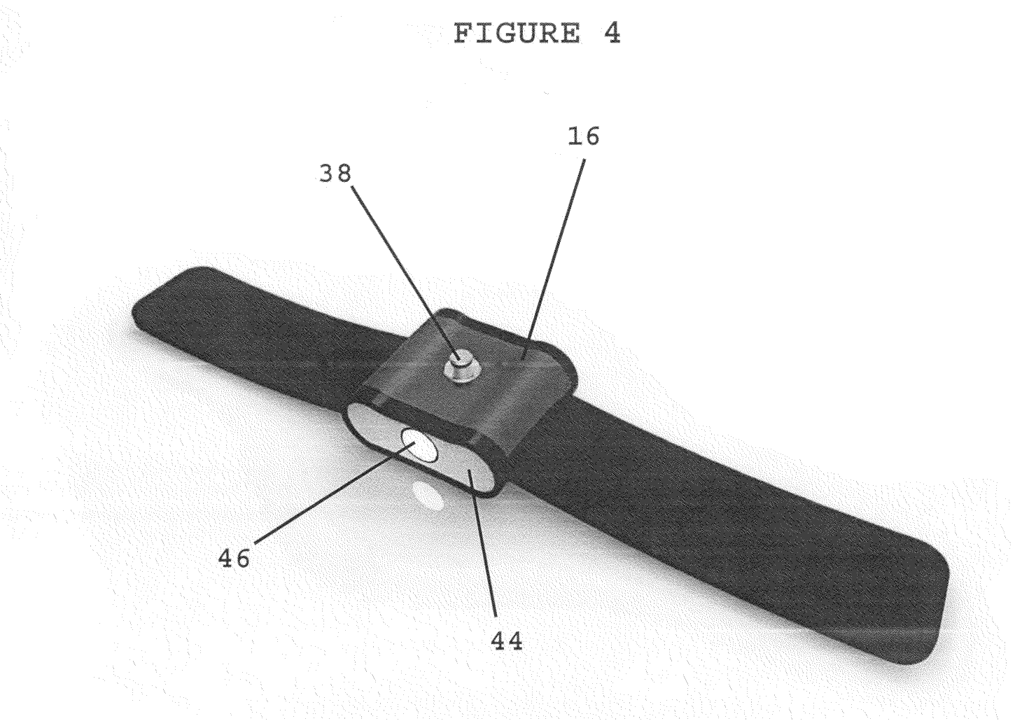

One possible embodiment of the invention is shown in FIG. 4 as a wearable wrist strap. Other renditions are possible as, but not limited to, heel strap and as a bench or vehicle mounted monitor.

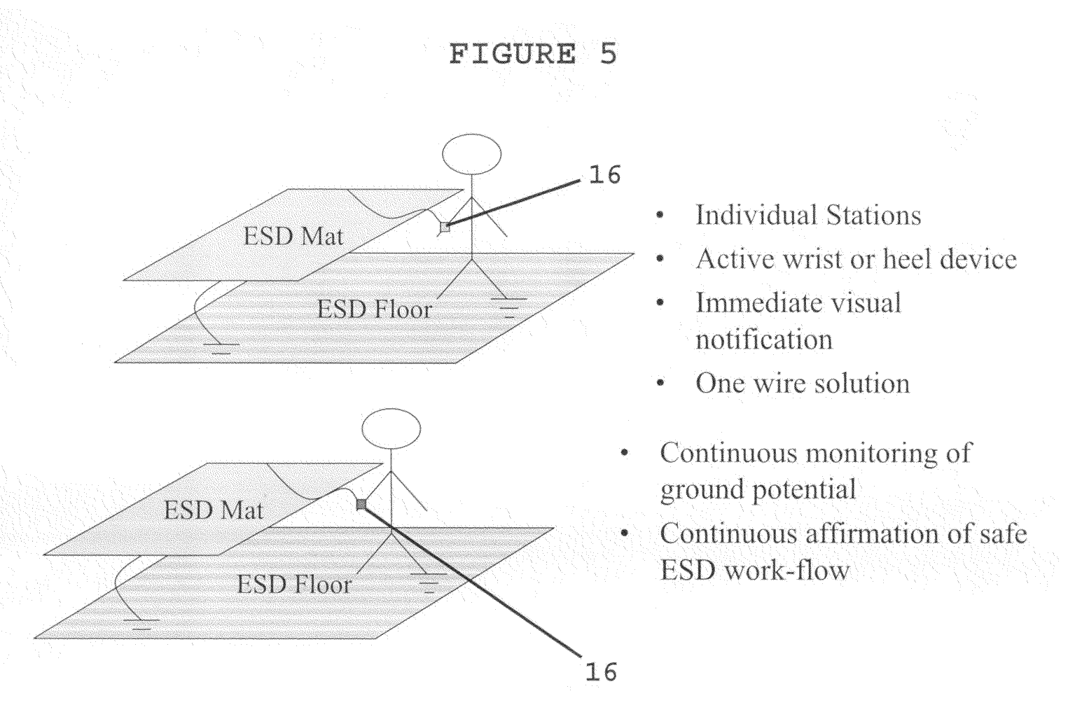

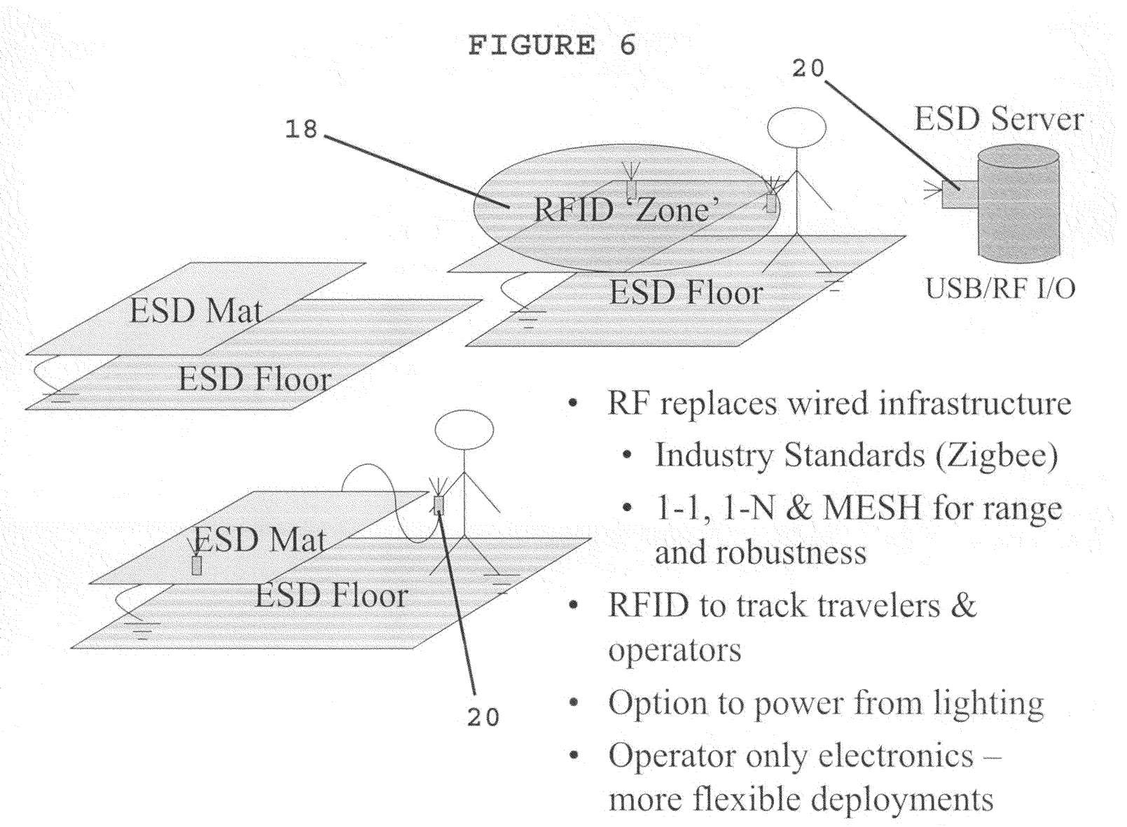

By using an wearable active wrist monitor 16, the operator is freed from expensive equipment installation and may work wherever there is an adequate ground connection as shown in FIG. 5. FIG. 6 shows alternate rendition as wrist/heal strap with RF communications and RFID tracking. The addition of RF communications and RFID to create a localized RFID Zone 18 with Wireless connectivity 20 significantly increase the utility of the invention.

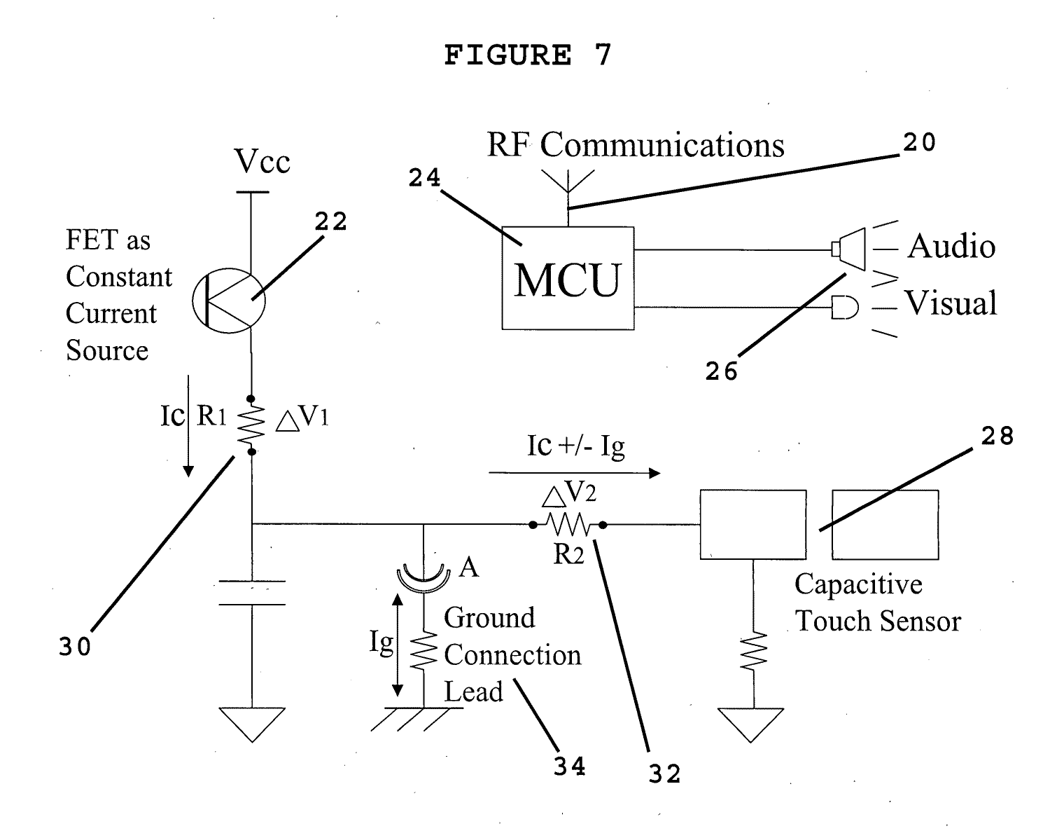

FIG. 7 is a principles of operation view of a ground monitoring sensing circuit. The device consists of a Constant Current Source 22 combined with the ability to measure current flow in two sensing resistors—sensing resistor R1 and sensing resistor R2. With no ground connection the same constant current (Ic) is measured across both R1 and R2 by MCU 24.

When the Ground connection lead 34 is connected to the Ground lead connection post 38, the ground connection causes discrete and quantifiable changes in current at R2. The system behaves as a ground loop antenna with increased gain with improvement in ground connectivity.

DSP algorithms running in the MCU 24 are used to do envelope detection of and correlation of the current flowing flowing through the Source current sensor 30 and the Loop current sensor 32 (R1 & R2). The MCU 24 is also used to measure the capacitance from A to digital ground. A combination of the change in local impedance and the integrated delta current flow between R1 and R2 can then be reduced to an ‘adequate ground connectivity’ true/false logic state. This logic state is used to drive suitable Audio/visual indicators 26 to the operator. Audio/visual feedback is via LED 44 or small pizzo Speaker 46 (FIG. 4).

In addition to monitoring connectivity state, it is also possible to monitor analog ground condition parameters and this data along with connectivity state may be transmitted to the base station and logged for calibration, correlation and audit purposes.

Two conductive capacitive touch pads in skin contact with the operator are used as a Capacitive touch sensor 28 to indicate that the device is being worn by the operator. One of these plates also provides ground continuity between the operator and earth.

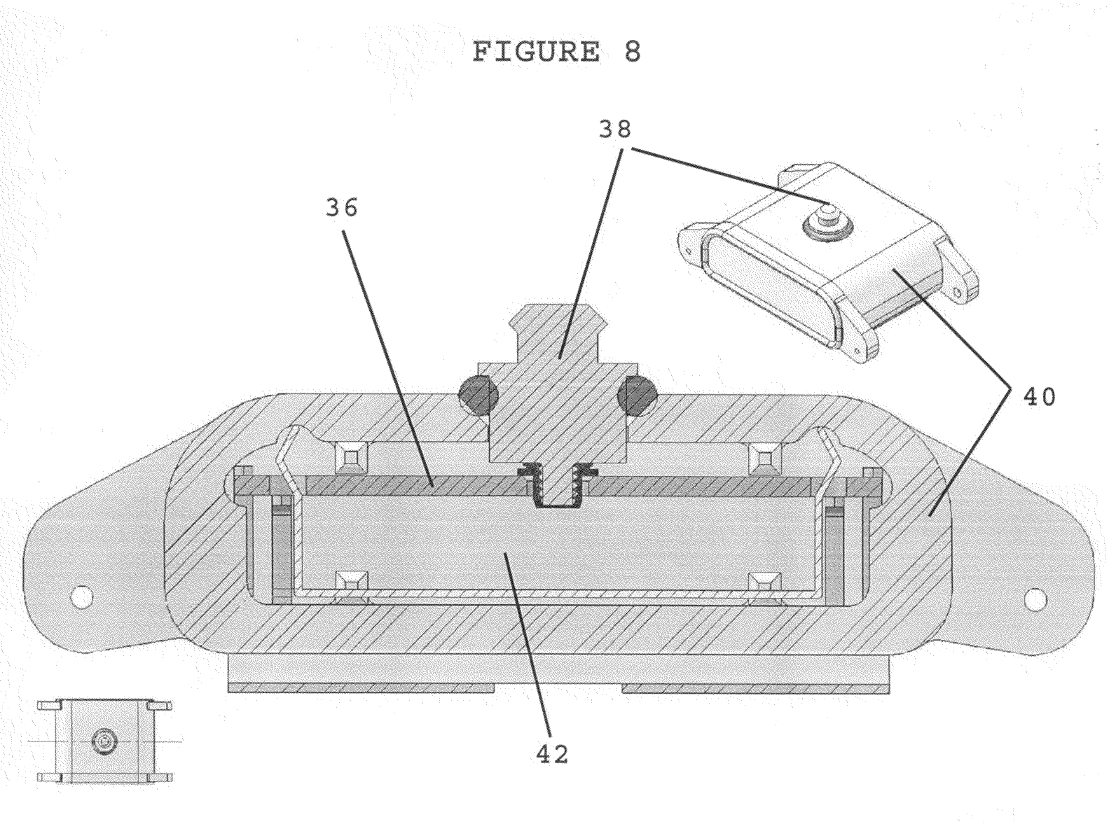

FIG. 8 shows a preferred embodiment, the Ground sensing circuit 36 is installed in a water resistant Wrist monitor body & wrist strap 40 with a Battery compartment 42 suitable for, but not limited to, a CR (coin-cell) Lithium battery. The whole enclosure being small enough to wear on an operators wrist.

Since other modifications and changes varied to fit particular operating requirements and environments will be apparent to those skilled in the art, the invention is not considered limited to the example chosen for purposes of disclosure, and covers all changes and modifications which do not constitute departures from the true spirit and scope of this invention.

Having thus described the invention, what is desired to be protected by Letters Patent is presented in the subsequently appended claims.

What is claimed is:

1. A wearable electronic ground integrity monitor for monitoring ground connection integrity of individuals working in electrostatic hazard operations, comprising:
means for actively monitoring and indicating ground connectivity state;
means for providing a constant current reference source used for baseline current loop monitoring;
means for monitoring and digital signal processing of current and local impedance changes, rf communications, audio/visual indicators, capacitive sensing of the operator;
means for providing ground connection state feedback;
means for the detection of operator presence;
means for source current detection & monitoring;
means for ground loop current detection and monitoring;
means for monitoring the ground connectivity state; and
means for water resistant, wearable enclosure.

2. The wearable electronic ground integrity monitor in accordance with claim 1, wherein said means for actively monitoring and indicating ground connectivity state comprises a wearable active wrist monitor.

3. The wearable electronic ground integrity monitor in accordance with claim 1, wherein said means for providing a constant current reference source used for baseline current loop monitoring comprises a constant current source.

4. The wearable electronic ground integrity monitor in accordance with claim 1, wherein said means for monitoring and digital signal processing of current and local impedance changes, rf communications, audio/visual indicators, capacitive sensing of the operator comprises a mcu.

5. The wearable electronic ground integrity monitor in accordance with claim 1, wherein said means for providing ground connection state feedback comprises an audio/visual indicators.

6. The wearable electronic ground integrity monitor in accordance with claim 1, wherein said means for the detection of operator presence comprises a capacitive touch sensor.

7. The wearable electronic ground integrity monitor in accordance with claim 1, wherein said means for source current detection & monitoring comprises a source current sensor.

8. The wearable electronic ground integrity monitor in accordance with claim 1, wherein said means for ground loop current detection and monitoring comprises a loop current sensor.

9. The wearable electronic ground integrity monitor in accordance with claim 1, wherein said means for monitoring the ground connectivity state comprises a ground sensing circuit.

10. The wearable electronic ground integrity monitor in accordance with claim 1, wherein said means for water resistant, wearable enclosure comprises a wrist monitor body & wrist strap.
